(19) United States
(12) Patent Application Publication
(10) Pub. No.: US 2011/0189494 A1
(43) Pub. Date: Aug. 4, 2011

(54) Aqueous Polymer Dispersion Useful for Preparing Base-Coat Composition for Embossed Leather

(76) Inventors: Leo Mario Saija, Bagnolo in Piano (IT); Mario Lugli, Fabbrico (IT)

(21) Appl. No.: 13/080,214

(22) Filed: Apr. 5, 2011

Related U.S. Application Data
(62) Division of application No. 11/720,680, filed on Jun. 1, 2007.

(51) Int. Cl. C14C 9/00; B32B 27/06

(52) U.S. Cl. 428/447; 252/8.57

(57) ABSTRACT

The invention relates to an aqueous polymeric dispersion comprising polymeric particles bearing silane and carboxylic groups, the said carboxylic groups being possible to be either in the form of acid or of its salt with monovalent cation, the said polymer particles being crosslinked by the presence of at least one multivalent metal compound selected from: oxides, hydroxides or its salts or complexes, with the Tg of the said polymer being not higher than 0° C. The invention also relates to a preparation process, to a composition for leather treatment comprising the said dispersion, to its use in the treatment of leather, in particular for embossed and automotive leather, and to a leather treated with the said composition.

The present invention relates to aqueous dispersions of polymers for the finishing treatment of leather. The invention specifically relates to dispersions useful for preparing base-coat composition for embossed leather, and more particularly for coating automotive leather, the said leather coating having a good cold crack resistance.

The films obtained from aqueous polymeric dispersions according to the present invention confer on the treated leather, an excellent compromise of performances in terms of mechanical resistance, low discoloration, embossing quality, intercoat adhesion and softness.

It is known, from the prior art, that the technique of finishing a leather, known as finishing, involves the use of polyurethane dispersions which are capable of forming films, which give a very good combination of properties to the end manufactured article but which exhibit the disadvantage of being too expensive.

To overcome this disadvantage of the polyurethane dispersions, several solutions are already proposed in the prior art and more particularly in the field of aqueous polymeric dispersions for aqueous coatings.

EP 1 160 335 discloses the use of a core-shell acrylic dispersion cross-linked with a divalent metal oxide, hydroxide or carbonate, or its salts or complex, having a low Tg core, functionalised with a carboxylic acid monomer, and a shell having a Tg higher than 20° C., polymerized in the presence of a chain transfer agent such as a mercaptan. This composition reduces the stiffness while improving the embossability of leather. However, this solution is inadequate in particular regarding the intercoat adhesion and low discoloration.

EP 1 208 117 discloses the use of an aqueous dispersion of acrylic polymers, comprising an unsaturated silane monomer, suitable for the finishing treatment of leather. This dispersion is exempted from (meth)acrolein and confers to the treated leather a good combination of softness, resistance to water and adhesion to the leather substrate. However, this prior art document does not disclose or teach the presence of any specific multivalent metal compound being essential mean of the present invention for the achievement of a satisfactory compromise of performances, in particular in terms of scrub resistance, absence of yellowing or of discoloration and higher embossing quality.

None of these prior art documents does provide a satisfactory solution to the problem of the protection of leather, and particularly to the protection of automotive leather, comprising an excellent compromise in terms of higher mechanical resistance including flexural and scrub resistance, resistance to embossing process, intercoat adhesion, colorless coating, softness and high cold crack resistance, even at low temperatures.

The present invention overcomes the disadvantages of the compositions of the prior art. The specific aqueous polymeric dispersions of the present invention are particularly suitable for the preparation of a base-coat composition for leather which satisfactorily meet the following needs and requirements:
an excellent intercoat adhesion on leather substrates, more particularly at low temperature, characterized by a good wettability of the polymer surface,
a good resistance to the embossing process, characterized by a high printability quality during a printing process,
a good profile of mechanical properties characterized by a good flexural resistance and scrub resistance, while keeping a high cold crack resistance at temperature lower than −10° C., and even at temperature lower than −15° C.,
a really colorless protective coating, in terms of yellowing and discoloration of the finished leather article,
a high softness, in terms of hand of the leather article, after it has been embossed and “drummed” for 12 hours.

The first subject-matter of the present invention is an aqueous polymeric dispersion.

The second subject-matter relates to a process for the preparation of the said polymeric dispersion.

The invention does also relate to a coating composition for leather treatment comprising at least one aqueous polymeric dispersion according to the invention and to the use of such a dispersion for leather treatment.

Finally, the invention concerns a leather article treated by a dispersion according to the invention.

More specifically, the first subject-matter of the invention is an aqueous polymeric dispersion comprising polymeric particles bearing silane and carboxylic groups, the said carboxylic groups being possible to be either in the form of acid or of its salts with monovalent cation, the said polymer particles being crosslinked by the presence of at least one multivalent metal compound selected from multivalent metal oxides, hydroxides or salts or complexes, and in that the Tg of the said polymer being not higher than 0° C., preferably not higher than −10° C., and more preferably from −20 to −50° C.

It must be specified that the said aqueous polymeric dispersion may be among others a pure acrylic dispersion involving acrylic and/or methacrylic or vinylic-acrylic dispersion or a styrene-acrylic dispersion.

As it concerns the valency of the said multivalent metal, preferably it should be higher than 1 and more preferably 2. Examples of such multivalent metal are zinc, calcium, magnesium, titanium, aluminium and zirconium with preferred ones being zinc and calcium more preferably zinc. Suitable metal compounds of these multivalent metals, for crosslinking the said aqueous polymeric dispersion are selected from metal oxides, like zinc oxide or calcium oxide or hydroxides, like zinc and calcium hydroxides or carbonates, like zinc and calcium carbonates or complexes of these metals with organic or inorganic ligands such as zinc ammonium carbonate.

Two possible cases may be considered in the definition of the Tg of the said polymer. In the first case where there is only a polymeric phase then the said Tg of the said polymer is considered to be the effective measurable Tg, while in the second case where the particle has a core/shell structure with two separated polymeric phases then the said Tg will be the calculated virtual Tg value obtained by the weighted average between Tg₁, the effective Tg of the first phase and Tg₂ the effective Tg of the second phase.

Consequently, the polymeric particles of the dispersion of the present invention may have a structural morphology with a structure of core/shell or they may have an homogeneous structure of a non structural latex. In the case of a structure of core/shell type, the Tg of the core is from −60 to −20° C., preferably from −50 to −30° C. and that of the shell from 50 to 150° C., preferably from 70 to 120° C. The weight ratio core/shell may be of 70/30 to 95/5.

Concerning the silane groups borne by the polymer particles of the invention they can be selected among alkoxysilanes, with alkoxy preferably in C₁-C₁₀, and more preferably in C₂-C₅. More specifically, preferred alkoxysilanes are selected from: tri-ethoxysilane, tri-isopropoxysilane, tri-methoxysilane, tri-(2-methoxyethoxy)silane, methyl dimethoxy silane, methyl diethoxy silane.

These silane groups may be issued from at least one α,β-ethylenically unsaturated monomer or oligomer further bearing at the least one silane group. Preferably, these monomers or oligomers bear besides silane group at least one ethylenic unsaturation which may be selected from: acrylic, vinylic, allylic. As example of acrylic monomer, we may cited methacryloxypropyl triisopropoxysilane, and as vinylic one vinyl trimethoxysilane.

The silane groups as defined according to the invention are suitable for interacting in the crosslinking process during the coalescence phase with the formation of bonds, preferably covalent bonds. Consequently, the use of monomers or oligomers bearing silane groups can contribute to improve the intercoat adhesion of the treated leather.

Suitable monomers or oligomers according to this invention bearing silane group may be represented by the following general formula (I):

CH₂═C(R)—Si(OR′)ₙR″ₘ or CH₂═C(R)—CO—O—R″—Si(OR′)ₙR″ₘ (I)

where:
n is an integer equal to 2 or 3,
m is an integer equal to 0 or 1,
m+n=3,

### R═H or CH₃,

R′═C₁-C₁₀ and preferably C₂-C₅ alkyl group, which may be linear or branched where possible,
R″═C₁-C₁₀ and preferably C₂-C₅ alkyl or alkylene group, depending on its position (alkyl if terminal, alkylene if not terminal), which may be linear or branched where possible.

Preferably, the monomers or oligomers bearing silane groups are present in the monomeric mixture in an amount corresponding to a weight ratio of 0.05 to 4 parts and more preferably of 0.1 to 2 parts for 100 parts of the total amount of monomers.

It should be specified that in the present invention as defined, the terms “monomeric mixture” and “amount of monomers” should be generally interpreted as including oligomers when present in the said monomeric mixture.

Concerning the carboxylic groups borne by the polymeric particles, their final form may be either as carboxylic acid or as a salt of this acid with monovalent cations, which cations may be of inorganic origin such as alkali metal cations or ammonium or cations of organic quaternary ammonium from tertiary amines. The acid or salt form may depend firstly on the initial form (initial acid or initial salt) of the carboxylic group borne by the selected monomer. A second possibility is by modifying (neutralizing) after polymerization the carboxylic acid group to the corresponding salt by using the adequate neutralizing agent corresponding to the said monovalent cation. Consequently, the final form of the carboxylic group will depend also from the final pH of the said aqueous dispersion.

The carboxylic acid group of the polymer particles can be issued from at least one ethylenically unsaturated monomer or oligomer bearing at least one carboxylic acid group or its corresponding anhydride or salt with a monovalent cation as defined above. More particularly, the said monomers can be selected from: methacrylic and acrylic acid, fumaric and maleic acid, itaconic acid, crotonic acid, methyl hemi-ester of itaconic acid, methyl hemi-ester of fumaric acid, butyl hemi-ester of fumaric acid or their corresponding salts with monovalent cations or where possible their corresponding anhydrides. Among preferred monomers of this type are: itaconic and (meth)acrylic acid.

The said ethylenically unsaturated monomer or oligomer bearing at least one carboxylic acid group or its corresponding anhydride or salt with monovalent cation is present in the monomeric mixture preferably at a weight ratio of 0.5 to 10 parts, and more preferably from 2 to 7 parts, for 100 parts of the total amount of monomers. As a consequence, the resulting acid value in equivalent of the final polymer of the dispersion of the invention, before ionic crosslinking, can vary from 5 to 100, and preferably from 10 to 50.

The term “equivalent acid” comprises the acid and salt forms of both carboxylic groups and phosphated groups.

In a more specific embodiment of the invention, the polymer particles may further bear at least a phosphated group selected from phosphates or phosphonates or phosphinates.

The said phosphated group can be issued from at least one ethylenically unsaturated monomer or oligomer bearing at least one phosphated group selected from phosphates or phosphonates or phosphinates as defined according to the following formulas:

phosphate type:

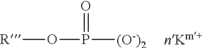

phosphonate type:

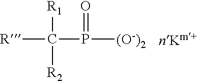

phosphinate type:

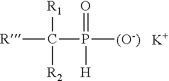

wherein,
R′″ comprises an ethylenic unsaturation which may be acrylic, vinylic or allylic, and where K⁺ is a monovalent cation, and preferably H⁺ or metallic cation or ammonium, and n′ and m′ are each equal to 1 or 2, so that n′×m=2;
R₁ and R₂, same or different, are selected from H, CH₃.
For example, K can be an alkaline metal or an ammonium cation.

Examples of phosphated monomers may comprise: alkoxylated methacrylate phosphates, vinyl phosphonic acid, hydroxyethyl methacrylate phosphate monoester and bi-ester, alkylmethacrylate phosphate monoester.

Preferred phosphated monomer is: hydroxyethyl methacrylate phosphate monoester.

The said ethylenically unsaturated monomer bearing at least one phosphated group is present in the monomeric mixture at a weight ratio of 0.1 to 5 parts, and preferably from 1 to 3 parts for 100 parts of the total amount of monomers.

The said carboxylic, silane and phosphated groups are preferably linked to the polymeric backbone by covalent bonds resulting from the polymerization of the corresponding monomers or oligomers bearing the said groups.

According to a specific embodiment, the dispersion of the invention can be obtained by emulsion polymerization of a monomeric mixture comprising additionally, besides the said monomers bearing carboxylic groups and the said monomers bearing silane group as defined according to the invention, and possibly the said monomers bearing phosphated group as defined according to the invention, at least one ethylenically unsaturated monomer selected from: methacrylic esters, allylic esters, vinylic esters, vinyl aromatic monomers, (meth)acrylonitrile.

More specifically, these additional monomers are monoethylenically unsaturated non-ionic monomers, such as for example the following ones: (meth)acxylic esters including methyl (meth)acrylate, ethyl (meth)acrylate, butyl (meth)acrylate, 2-ethylhexyl (meth)acrylate, decyl (meth)acrylate, hydroxyethyl (meth)acrylate, hydroxypropyl (meth)acrylate, styrene or substituted styrene derivatives, (meth)acrylonitrile and vinyl acetate or other vinyl esters.

More particularly, the monomeric mixture for preparing the dispersion according to the present invention the said monomeric mixture may further comprise at least one monomer bearing at least two polymerizable ethylenic unsaturations.

Examples of such polymerizable ethylenic unsaturations (at least two) may be acrylic, vinylic or allylic ones, with as examples of suitable monomers which may be cited: (tri)ethyleneglycol di(meth)acrylate or allyl methacrylate.

The said additional monomer bearing at least two polymerizable ethylenic unsaturations may be present at a weight ratio of 0.05 to 2 parts for 100 parts of the total amount of monomers.

The composition and type of the monomers or oligomers in the monomeric mixture will be selected so that the essential Tg and the functionality requirements for the final polymer as defined above are fully fulfilled.

The said final dispersion of the invention is obtainable by a process comprising besides the emulsion polymerization step of a specific monomeric mixture as defined above, an additional and subsequent step of cross-linking of the polymeric particles by adding at least one multivalent metal oxide, hydroxide or its salt or complex. The said multivalent metal oxide, hydroxide or its salt or complex, is added in an amount corresponding to a molar ratio multivalent metal/total equivalent acid from carboxylic and possibly phosphated groups from 0.05 to 2.00, and preferably from 0.1 to 1. In fact, this molar ratio takes into account the total equivalent acidity resulting from carboxylic groups or phosphated groups and their salts. Preferably, the metal compound is added in the form of an aqueous slurry or of an aqueous solution in water, optionally with an added polymeric dispersant such as, for example a low molecular weight homopolymer or copolymer of (meth)acrylic acid. The said transition metal oxide, hydroxide, or its salts or complex, may be added in a water-soluble form such as a solution of zinc ammonium carbonate before or after the formation and the neutralization of the emulsion polymer. The final pH of the dispersion is between 7 and 8.5.

The size of the particles of the dispersion varies from 70 to 150 nm, and preferably from 80 to 120 nm.

The dry extract obtained for the dispersion is between 30 and 50%, and preferably between 30 and 45%.

The metal oxide, hydroxide or its salt such as carbonate or complex, is capable of interacting with acid equivalent groups (carboxylic or phosphated) during the coalescence phase leading to an ionic crosslinking process by the formation of ionic bonds. The use of the said metal compounds contributes to improve the embossability of leather and to significantly lower the yellowing and discoloration of the finished leather article.

The oxides, hydroxides and carbonates of zinc, calcium, magnesium, titanium, aluminium, and zirconium are preferred for low cost, low toxicity, and low color in the dried coating. Zinc oxide is the more preferred.

A second subject of the present invention concerns a process for preparing the said dispersion of the invention. The said process comprises besides the emulsion polymerization step of the said monomeric mixture an additional and subsequent step of crosslinking of the resulting polymer particles by adding at least one multivalent metal oxide, hydroxide or its salt or complex, preferably in the form of an aqueous slurry or of an aqueous solution as specified above.

This process comprises at least the following essential steps:
i) emulsion polymerization of a monomeric mixture comprising:
   a) at least one ethylenically unsaturated monomer bearing at least one silane group as defined according to the invention,
   b) at least one ethylenically unsaturated monomer bearing at least one carboxylic group as defined according to the invention,
ii) crosslinking of the resulting polymer particles by adding in the said emulsion of step i) at least one multivalent metal oxide, hydroxide or its salt or complex in the form of slurry or aqueous solution.

More specifically it comprises the following steps:
i) emulsion polymerization of a first monomeric mixture comprising:
   a) at least one ethylenically unsaturated monomer bearing at least one silane group as defined according to the invention,
   b) at least one ethylenically unsaturated monomer bearing at least one carboxylic group as defined according to the invention,
ii) addition and emulsion polymerization of a second monomeric mixture, different in composition from that of step i), until having complete conversion of the total of monomers, crosslinking of the resulting polymer particles of the final emulsion resulting from step by adding at least one multivalent metal oxide, hydroxide or its salt or complex at a molar ratio of multivalent metal/total equivalent acid from carboxylic and possibly phosphated groups from 0.05 to 2.00, and preferably from 0.1 to 1.

In case of a core-shell structure, the specific process comprises at least the following stages:
i) polymerization in at least one stage of a monomeric mixture as defined according to the invention,
ii) polymerization in at least one stage of at least one second monomeric mixture as defined according to the invention, it being possible for this second monomeric mixture to give a polymer with a different Tg value from that of stage i).

During a first stage, the nucleation of the polymer particles can be carried out in situ by carrying out a batch introduction of a small proportion of the monomers used for the complete process and of a sufficient amount of a radical initiator or of a seed prepared beforehand. It is also possible to directly initiate the second stage without passing through a nucleation stage.

The second stage consists in running in semi-continuously a solution or a pre-emulsion of monomers and a solution of radical initiator. This second stage can furthermore be subdivided into several sub-stages during the feeding to the reaction medium of a mixture of monomers.

The third stage of the process relates to the reduction of the residual monomers in the final composition. This is achieved by semi-continuously feeding in various solutions of radical initiators in the presence or absence of activator which are reducing agents as described above.

The reaction mixture is subsequently cooled during the final stage of the process, until reaching room temperature, when the additives and neutralizing agent are also added.

Another subject-matter of the invention is a coating composition for leather treatment comprising at least one dispersion as defined according to the invention or obtainable by a process as defined according to the invention. This composition can be a base coat composition for embossed leather. More particularly, the said composition can be a composition for automotive leather application, and preferably a composition for a treatment of leather with cold crack resistance at a temperature lower than −10° C., and preferably lower than −15° C.

A typical coating composition for leather treatment may comprise:
a) a dispersion according to the invention,
b) at least one wax emulsion, the said wax being selected from polyethylene wax, polyethylene oxidized wax, carnauba wax,
c) at least organic or inorganic pigment, such as TiO₂ or carbon black,
d) at least one associative thickener, such as polyurethane type.

A typical solids content of this coating composition could be from 25% to 35%.

An additional subject-matter of the invention is the use of the dispersion of the invention, or obtainable by a process as defined according to the invention, for the treatment of leather, and particularly for the treatment of embossed leather, and more particularly for the treatment of automotive leather, in the form of a base coat composition. More particularly, the said treatment is for leather with cold crack resistance to a temperature lower than −10° C., and preferably lower than −15° C.

A final subject-matter of the present invention is a leather treated with at least one composition of treatment as defined according to the invention or according to the use as defined according to the invention. More particularly, it is noted that the treated leather, embossed or for automotive, has a good cold crack resistance even at a temperature lower than −15° C.

By way of illustration of the invention, the following examples demonstrate, without any limitation, the performances of the dispersions and coatings obtained.

### Preparation and Characterization of the Polymer Dispersion:

### EXAMPLE 1

### Invention

In a glass reactor, equipped with condenser, stirrer, temperature control system and inlet for nitrogen, initiator solutions and pre-emulsion feeding, 2694 g of deionized water are added together with 16.3 g of sodium lauryl sulphate. In another vessel, equipped with stirrer (pre-emulsifier) an emulsion is prepared, constituted of 1676 g of deionized water, 19.4 g of sodium lauryl sulphate, 139.1 g of methacrylic acid, 1920 g of ethyl acrylate, 898 g of butyl acrylate, 12 g of methacryloxy propyl triisopropoxy silane and 3.0 g of triethyleneglycol dimethacrylate.

When the reactor reaches the temperature of 50° C., 150 g of the previously prepared monomer pre-emulsion are transferred therein and in sequence 6.2 g of sodium persulphate 10% solution, 20 mg of ferrous sulphate and 2.5 g of sodium metabisulphite 10% solution.

When the polymerization starts, the temperature inside the reactor will increase of about 10° C. (exothermic peak). One minute after the reaching of the exothermic peak, the remaining part of monomer emulsion together with 200 g of sodium persulphate 5% solution, and 12.5 g of sodium metabisulphite 10% solution, are added at a constant rate, for 4 hours to the reactor, taking care of maintaining the reactor content at temperature of 60° C. Then 5.5 g of terbutylhydroperoxide are dissolved in 35 g of deionized water and 3.2 g of sodium formaldehyde sulphoxylate dissolved in 77 g of water, are added at a constant rate, in 75 minutes. The reaction mixture is maintained at 60° C. for an additional half an hour, and then it is cooled at a temperature of 35° C. and a slurry of 29.3 g of zinc oxide in 187 g of deionized water is added. After an additional half an hour, the reactor content is bring to a pH of 8.0 with the addition of 64 g of a 28 degrees Bé ammonia (approximately 31% by weight) and cooled at room temperature. The obtained dispersion filtered on a 36 Mesh, is characterized by a dry residue of 37.8% (1 h at 105° C.), a pH of 8.0, a content of precoagulum lower than 200 ppm on a 275 Mesh net and a viscosity of 44 mPa·s (Brookfield RVT at 100 rpm and 23° C.).

### EXAMPLE 2

### Comparative

The procedure described in Example 1 is followed, without adding the 29.3 g of zinc oxide.

The obtained dispersion filtered on a 36 Mesh, is characterized by a dry residue of 37.4% (1 h at 105° C.), a pH of 8.1, a content of precoagulum lower than 200 ppm on a 275 Mesh net and a viscosity of 40 mPa·s (Brookfield RVT at 100 rpm and 23° C.).

### EXAMPLE 3

### Comparative

The procedure described in Example 1 is followed, without adding the 12 g of methacryloxypropyl triisopropoxy silane in the monomer pre-emulsion.

The obtained dispersion filtered on a 36 Mesh, is characterized by a dry residue of 37.6% (1 h at 105° C.), a pH of 7.8, a content of precoagulum lower than 200 ppm on a 275 Mesh net and a viscosity of 38 mPa·s (Brookfield RVT at 100 rpm and 23° C.).

### EXAMPLE 4

### Invention

In a glass reactor, equipped with condenser, stirrer, temperature control system and inlet for nitrogen, initiator solutions and pre-emulsion feeding, 2754 g of deionized water are added together with 26.8 g of sodium lauryl sulphate. In another vessel, equipped with stirrer (pre-emulsifier) an emulsion is prepared, constituted of 1170 g of deionized water, 10.0 g of sodium lauryl sulphate, 75.2 g of itaconic acid, 2408 g of butyl acrylate, 50.2 g of hydroxy ethyl methacrylate phosphate acid (monoester) and 3.0 g of triethyleneglycol dimethacrylate.

When the reactor reaches the temperature of 50° C., 155 g of the previously prepared monomer pre-emulsion are transferred therein and in sequence 24.8 g of sodium persulphate 10% solution, 40 mg of ferrous sulphate and 10.8 g of sodium metabisulphite 10% solution.

When the polymerization starts, the temperature inside the reactor will increase of about 10° C. (exothermic peak). One minute after the reaching of the exothermic peak, the remaining part of monomer emulsion together with 200 g of sodium persulphate 5% solution, and 40.0 g of sodium metabisulphite 10% solution, are added at a constant rate, for 4 hour to the reactor, taking care of maintaining the reactor content at temperature of 60° C. After 3 hours from the feeding start, 3.8 g of methacryloxypropyl triisopropoxy silane are added to the monomer pre-emulsion. When the feeding of the remaining pre-emulsion is over, the reactor content is maintained at a 60° C. for an additional half an hour. Then a second monomer pre-emulsion, composed by 290 g of deionized water, 2.1 g of sodium lauryl sulphate, 410 g of methyl methacrylate, and 6.4 g of methacryloxypropyl triisopropoxy silane, together with 2 g of terbutyl hydroperoxide dissolved in 12 g of deionized water, and 1.5 g of sodium formaldehyde sulphoxylate dissolved in 35.7 g of deionized water, are added at a constant rate in 20 minutes in the reactor, taking care of maintaining the reactor content at a temperature of 60° C. After the end of the second pre-emulsion feeding, 7.8 g of terbutyl hydroperoxide dissolved in 52.2 g of deionized water and 6.4 g of sodium formaldehyde sulphoxylate dissolved in 153.6 g of water, are added at a constant rate, in 75 minutes. The reaction mixture is maintained at 60° C. for an additional half an hour, at the end of which it is cooled to the temperature of 35° C. and a slurry of 29.3 g of zinc oxide in 187 g of deionized water is added. After an additional half an hour the reactor content is bring to a pH of 8.0 with the addition of 65 g of a 28 degrees Bé ammonia and cooled at room temperature. The obtained dispersion filtered on a 36 Mesh, is characterized by a dry residue of 37.3%. (1 h at 105° C.), a pH of 8.0, a content of precoagulum lower than 200 ppm on a 275 Mesh net and a viscosity of 60 mPa·s (Brookfield RVT at 100 rpm and 23° C.).

### EXAMPLE 5

### Comparative

The procedure described in Example 4 is followed, without adding the 5.8 g and then the 6.4 g of methacryloxypropyl triisopropoxy silane. Besides, the quantity of itaconic acid added is 125.4 g.

The obtained dispersion filtered on a 36 Mesh, is characterized by a dry residue of 37.1% (1 h at 105° C.), a pH of 7.8, a content of precoagulum lower than 200 ppm on a 275 Mesh net and a viscosity of 45 mPa·s (Brookfield RVT at 100 rpm and 23° C.).

### Characterization of the Polymer Films:

The polymer films obtained by drying the dispersion in suitable PTFE vessels, were subjected to physico-chemical characterization after conditioning for 7 days in a controlled environment at a relative humidity of 50% and at a temperature of 23° C.

The polymer films are evaluated for:
Tensile strength and elongation at break, which are linked with the flexion endurance of the finished leather.
The measures have been carried out with the method DIN 53455, using an ACQUATI AG8E dynamometer, with specimen of R type and a traction speed of 300 mm/min.
Hardness Shore A which is straightly connected with the hand of the leather article.
The measures have been carried out on 3 mm thick polymer films, according with the ASTM D2240 standard.
Yellowing which is directly linked with the yellowing of the finished leather article.
The yellowing has been measured straightly on 1 mm thick polymer films by measuring their colors, with a X-Rite reflectance spectrophotometer SP60 type. The color characteristics are summarized by the a and b coordinates in CIE L*a*b* color space. An a* (red-green) coordinate positive value indicates redness and a negative a* value indicates greenness. A positive b* (Yellow-blue) value indicates yellowness and a negative b* value indicates blueness.
Wetting as the intercoat adhesion is straightly linked with the wettability of the leather surface, after being coated with the formulation based on the polymer dispersion, with other water based finishing treatment, second base-coat hand or top coat hand. Higher wettability of the polymer surface grants to higher intercoat adhesion.
The wettability evaluation has been carried out by recognizing the surface wetted by a 200 μl water drop spread by a 25 μm coating bar on a 80 μm thick, and 10 cm wide, dry polymer dispersion films. The result is expressed on a scale from 1 to 5, where 5 indicates the complete wetting of the polymer film when the drop is spread immediately on all the polymer film wideness, whereas 1 means that the water drop has wetted a stripe wide almost as the initial drop.

### Characterization of the Finished Leather Obtained:

The finishing treatment is carried out on split calfskins using a formulation based on a polymer dispersion with the following formula:

TABLE 1

| Constituent | Weight amounts |
|---|---|
| Polyethylene emulsion wax (30%) | 15 |
| TiO₂ dispersion (25%) | 15 |
| Dispersion of the invention | 81 |
| Polyurethane thickener (25%) | 1.25 |
| Water | 16 |

The formulation is applied by spraying, in such a way that, after drying for 10 minutes at 60° C., it gives an amount of 200-250 g/m². The leather is subsequently subjected to a printing process at a temperature of approximately 90° C., under a pressure of 300 bars and for a contact time of approximately 5 seconds. The printed leather is subsequently finished with a thin layer based on nitrocellulose.

The finished leather is evaluated for:

Cold Crack Temperature:
The evaluation of the cold crack temperature has been carried out according with the ISO 17233/02 method.

Embossing Quality:
The quality of the printing process is evaluated by monitoring the resistance of a formulation to cracking in the printing process, the definition and the retention of the printed grain. The result is expressed on a scale from 1 to 5, where 5 indicates the complete absence of microcracks and a very good retention of the impression, whereas 1 means a completely cracked finish and/or the absence of retention of the impression.

Hand:
The hand of the finished leather is valued by touching the leather article after it has been embossed and “drummed” for 12 hours. The result is expressed on a scale from 1 to 5, where 5 indicates that the article still retain the hand and the softness of the natural leather, whereas 1 means a more stiff finished article with an heavy plastic hand.

Flexion Endurance (Bally) at Room Temperature and in Some Case at Low Temperature:
Use is made, in determining the dry flex behavior of leathers finished with the formulations obtained from the polymer dispersions of the invention, of a Bally flexometer according to the process based on the IUF 20 standard of the International Union of Leather Technologists and Chemists Societies. The test specimens (65×40 mm) are subjected to bending movements and examined after a certain number of cycles. The test is interrupted at the number of cycles where 10 or more cracks have appeared in the finish. Even though the extent of the damage depends on the type of leather used in the test, a resistance equal to approximately 10 000 bending movements is regarded as acceptable.

Scrub Endurance (VESLIC) at Room Temperature:
The Veslic C4500 method is used to determine the wet scrub resistances of the finished leathers. Dry leather test specimens with dimensions of 115*38 mm are abraded with a moist felt wad loaded with a pressure of 1 kg/cm². The number of cycles necessary to transfer a slight coloring to the wad is recorded.

TABLE 2

| | Polymer Films | | Tensile | |
|---|---|---|---|---|
| | Shore A | Yellowing | Strenght at | Elongation at |
| Sample | Hardness | (b) | Break (MPa) | Break (%) |
| Example 1 | 31 | 3.60 | 5.0 | 680 |
| (Invention) | | | | |
| Example 2 | 17 | 4.13 | 1.5 | 730 |
| (Comparative) | | | | |
| Example 3 | 28 | 5.27 | 3.5 | 740 |
| (Comparative) | | | | |

TABLE 3

| | Flexion | Scrub | | | |
|---|---|---|---|---|---|
| | Endurance | Endurance | | | |
| | at | at | Cold | | |
| | 23° C. | 23° C. | Crack | | |
| | (Bally) | (Veslic) | Tempera- | | |
| | (N^{o} | (N^{o} | ture | Embossing | |
| Sample | of cycles) | of cycles) | (° C.) | Quality | Hand |
| Example 1 | >100000 | 500 | −15 | +++++ | ++++ |
| (Invention) | | | | | |
| Example 2 | >100000 | 200 | −15 | + | ++++ |
| (Comparative) | | | | | |
| Example 3 | >100000 | 300 | −15 | + | +++ |
| (Comparative) | | | | | |

TABLE 4

| | Polymer Films | | Tensile | |
|---|---|---|---|---|
| | Hardness Shore | | Strenght | Elongation at |
| Sample | A | Wetting | at Break (MPa) | Break (%) |
| Example 4 | 43 | 5 | 5.0 | 670 |
| (Invention) | | | | |
| Example 5 | 50 | 4 | 4.6 | 545 |
| (Comparative) | | | | |

TABLE 5

| | | Flexion | | |
|---|---|---|---|---|
| | Flexion | Endurance | | |
| | Endurance | at −35° C. | | |
| | at 23° C. | (Bally) | Cold Crack | |
| | (Bally) | (N^{o} of | Temperature | Embossing |
| Sample | (N^{o} of cycles) | cycles) | (° C.) | Quality |
| Example 4 | 220000 | 15000 | −35 | +++++ |
| (Invention) | | | | |
| Example 5 | 140000 | 12000 | −35 | + |
| (Comparative) | | | | |

1-25. (canceled)

26. A method for treating leather, the method comprising applying a base coat composition comprising an aqueous polymeric dispersion to leather,
characterized in that said dispersion comprises polymeric particles bearing silane and carboxylic groups and optionally phosphated groups, the said carboxylic groups being either in the form of acid or of its salts with monovalent cation, the said polymeric particles being ionically crosslinked by the presence of at least one multivalent metal compound selected from zinc, calcium, magnesium, titanium, aluminum and zirconium, said metal compound being in the form of an aqueous slurry or of an aqueous solution and being selected from multivalent metal oxides, hydroxides or salts or complexes, and in that the Tg of the said polymeric particles is not higher than 0° C., the said carboxylic groups of the said polymeric particles being issued from at least one ethylenically unsaturated monomer or oligomer bearing at least one carboxylic acid group or its corresponding anhydride or salt with a monovalent cation, and being present in the monomeric mixture at a weight ratio of 0.5 to 10 parts for 100 parts of the total amount of monomers, the said multivalent metal oxide, hydroxide or its salt or complex, being added in an amount corresponding to a molar ratio multivalent metal/total equivalent acid from carboxylic and possibly phosphated groups from 0.05 to 2.00.

27. A method for treating leather according to claim 26 characterized in that it is a treatment for embossed leather.

28. A method for treating leather according to claim 26 characterized in that it is a treatment for automotive leather.

29. A method for treating leather according to claim 26 characterized in that it is a treatment for a leather with cold crack resistance at a temperature lower than −10° C.

30. A method for treating leather according to claim 26 characterized in that the said base-coat composition comprises:
a) an aqueous polymeric dispersion as defined according to claim 26,
b) at least one wax emulsion,
c) at least one organic or inorganic pigment, and
d) at least one associative thickener.

31. A method for treating leather according to claim 26 characterized in that the solids content of said base-coat composition is from 25 to 35%.

32. A method for treating leather according to claim 26 characterized in that the said polymeric particles have a Tg not higher than −10° C.

33. A method for treating leather according to claim 26 characterized in that the said polymeric particles have a core/shell structure.

34. A method for treating leather according to claim 26 characterized in that the said polymer particles further bear a phosphated group selected from phosphates or phosphonates or phosphinates.

35. A method for treating leather according to claim 26 characterized in that the said silane group is selected from alkoxysilanes.

36. A method for treating leather according to claim 26 characterized in that the said silane groups are issued from at least one α,β-ethylenically unsaturated monomer or oligomer further bearing at least one silane group, the ethylenic unsaturation being selected from the group consisting of acrylic, vinylic, and allylic groups.

37. A method for treating leather according to claim 30 characterized in that the said monomer or oligomer bearing at least one silane group is of the following general formula:
CH₂═C(R)—Si(OR′)ₙR″ₘ or CH₂═C(R)—CO—O—R″—Si(OR)ₙR″ₘ
where:
n is an integer equal to 2 or 3,
m is an integer equal to 0 or 1,
m+n=3,
R═H or CH₃,
R′═C₁-C₁₀ alkyl group, and
R″═C₁-C₁₀ alkyl or alkylene group.

38. A method for treating leather according to claim 37 characterized in that R′═C₂-C₅ alkyl group and R″═C₂-C₅ alkyl or alkylene group.

39. A method for treating leather according to claim 30 characterized in that the said monomer or oligomer bearing silane groups is present at a weight ratio of 0.05 to 4 parts for 100 parts of the total amount of monomers.

40. A method for treating leather according to claim 26 characterized in that the said monomer is selected from: methacrylic and acrylic acid, fumaric and maleic acid, itaconic acid, crotonic acid, methyl hemi-ester of itaconic acid, methyl hemi-ester of fumaric acid, butyl hemi-ester of fumaric acid or their corresponding salts with monovalent cations or where possible their corresponding anhydrides.

41. A method for treating leather according to claim 29 characterized in that the said phosphated groups are issued from at least one ethylenically unsaturated monomer or oligomer bearing at least one phosphate or phosphonate or phosphinate group.

42. A method for treating leather according to claim 35 characterized in that the said ethylenically unsaturated monomer or oligomer bearing at least one phosphated group is present in the monomeric mixture at a weight ratio of 0.1 to 5 parts for 100 parts of the total amount of monomers.

43. A method for treating leather according to claim 33 characterized in that the core has a Tg from −60° C. to −20° C. and that the shell has a Tg from 50 to 150° C.

44. A method for treating leather according to claim 26 characterized in that the said dispersion is obtained by emulsion polymerization of a monomeric mixture comprising additionally, besides the said monomers bearing carboxylic groups as defined according to claim 26, and the said monomers bearing silane group are selected from alkoxysilanes, and possibly the said monomers bearing phosphated group that are issued from at least one ethylenically unsaturated monomer or oligomer bearing at least one phosphate or phosphonate or phosphinate group, at least one ethylenically unsaturated monomer selected from the group consisting of methacrylic esters, allylic esters, vinylic esters, vinyl aromatic monomers, and (meth)acrylonitrile.

45. A method for treating leather according to claim 26 characterized in that the said dispersion is obtained by a process comprising besides an emulsion polymerization step of the said monomeric mixture, an additional and subsequent step of cross-linking of the polymeric particles by adding at least one multivalent metal oxide, hydroxide or its salt or complex in the form of an aqueous slurry or of an aqueous solution.

46. A method for treating leather according to claim 26 characterized in that it is a treatment for embossed leather, the said base-coat composition comprising:
a) an aqueous polymeric dispersion as defined according to claim 26,
b) at least one wax emulsion,
c) at least one organic or inorganic pigment, and
d) at least one associative thickener.

47. A method for treating leather according to claim 26 characterized in that it is a treatment for automotive leather, the said base-coat composition comprising:
a) an aqueous polymeric dispersion as defined according to claim 26,
b) at least one wax emulsion,
c) at least one organic or inorganic pigment, and
d) at least one associative thickener.

48. A method for treating leather according to claim 26 characterized in that it is a treatment for a leather with cold crack resistance at a temperature lower than −10° C., the said base-coat composition comprising:
a) an aqueous polymeric dispersion as defined according to claim 26,
b) at least one wax emulsion,
c) at least one organic or inorganic pigment, and
d) at least one associative thickener.

49. Treated leather characterized in that it is treated by a method as defined according to claim 26.

50. Treated leather characterized in that it is an embossed leather treated by a method as defined according to claim 26.

51. Treated leather characterized in that it is an automotive leather treated by a method as defined according to claim 26.
